(19) United States
(12) Patent Application Publication
(10) Pub. No.: US 2008/0177555 A1
(43) Pub. Date: Jul. 24, 2008

(54) Automated Voting District Generation Using Preexisting Geopolitical Boundaries

(76) Inventors: David W. Peterson, Pittsboro, NC (US); Claire Ellis Osgood, Durham, NC (US)

Correspondence Address: COATS & BENNETT, PLLC, 1400 Crescent Green, Suite 300, Cary, NC, 27518, US

(21) Appl. No.: 11/626,436

(22) Filed: Jan. 24, 2007

(51) Int. Cl. G06Q 99/00

(52) U.S. Cl. 705/1

(57) ABSTRACT

To assist the task of redistricting a region, such as a state, the region is divided into one or more sets of “super districts” that exactly cover the region. Each super district comprises one or more contiguous counties or other preexisting geopolitical sub-divisions, and contains an integral multiple of the required district population, to within a predetermined tolerance. A plurality of such sets, or super district covers, may be created, such as via a computer program. The task of creating voting districts then becomes one of selecting a super district cover as a starting point, and then dividing the super districts containing a multiple of the required population into voting districts.

### BACKGROUND

Article I, section 3 of the U.S. Constitution stipulates that Representatives are apportioned among the states according to population, which shall be Enumerated every ten years. States implement this mandate by creating a number of voting districts, of substantially equal population, equal to the number of Representatives apportioned to the state. At every decennial census—or, as the Supreme Court affirmed in a 2006 Texas redistricting case (League of United Latin American Citizens et al. v. Perry, Governor of Texas, et al.), at virtually any time the legislature wishes—these congressional districts must be redrawn. Many states similarly create voting districts of substantially equal population for the election of one or more houses of the state legislature, which districts must be redrawn as the population distribution changes.

Political mischief has been a part of redistricting almost from the start—a practice dubbed “gerrymandering” when Massachusetts governor Elbridge Gerry's Anti-Federalist party created an odd-shaped district in 1812 that artist Gilbert Stuart rendered in an editorial drawing as a salamander. Gerrymandering has been a fact of American politics for two centuries. In 1996, the Supreme Court considered the constitutionality of North Carolina's District 12 (Shaw v. Hunt, 517 U.S. 899, 116 S.Ct.1894, 135 L.Ed.2d 207), which followed the I-85 corridor for nearly 160 miles, connecting disparate African-American neighborhoods. At points, the district was no wider than I-85 itself, prompting one state legislator to remark, “If you drove down the interstate with both car doors open, you'd kill most of the people in the district.” Political affiliation is an even more common basis for gerrymandering than race, as incumbent legislators draw district boundaries to entrench their position and that of their political party. As one observer noted, voters used to choose their legislators, but now legislators choose their voters.

To remove some of the latitude for gerrymandering, the North Carolina Supreme Court ruled in 2002 (Stephenson I, 335 N.C. at 383-84, 562 S.E.2d at 396-98) that voting districts for state legislative elections must follow existing county boundaries to the extent possible consistent with the federal Voting Rights Act and federal law. Even in states where such a mandate is not ordered by the court, using existing county lines to draw voting districts has several advantages. Counties play a vital role in many areas touching the everyday lives of citizens. For example, counties typically effect the administration of justice within their borders, and each has a jail and a courthouse where cases arising in the county are usually tried. Each county elects a sheriff. Soil and water conservation districts oversee watershed programs and drainage issues in many counties. Each county is responsible for administering the public schools by way of a county board of education. In general, many people identify themselves as residents of their counties and customarily interact most frequently with their government at the county level.

Population density across a state is rarely so uniform that counties may each be considered a voting district, containing an equal share of the population. Populous counties must be sub-divided, and rural counties aggregated, to form voting districts. However, using county lines to the greatest extent possible in defining voting districts preserves the public's inherent identity with their county, leverages the existing county administrative infrastructure, and minimizes the opportunity for political manipulation in redistricting. However, the mechanics of such redistricting are daunting due to the large number of ways in which counties may be aggregated or split to meet the equal-population requirement.

### SUMMARY

In one or more embodiments of the present invention, a region, such as a state, is divided into a set of “super districts.” Each super district comprises one or more contiguous counties or other preexisting geopolitical sub-divisions, and includes an integral multiple of the required district population, to within a predetermined tolerance. The task of creating districts then becomes one of dividing the super districts containing a multiple of the required population greater than one, with the potential for political manipulation being hence limited to that task.

In one embodiment, the present invention relates to a method of assisting the division of a region into a predetermined number of contiguous, non-overlapping districts that completely cover the region, each district having the same population to within a predetermined tolerance, making maximum use of preexisting geopolitical boundaries. At least one super district cover comprising a set of contiguous, non-overlapping super districts that completely cover the region is automatically generated, each super district defined entirely by preexisting geopolitical boundaries and containing an integer multiple of the required district population to within the predetermined tolerance.

In another embodiment, the present invention relates to a computer readable medium including one or more computer programs operative to cause a computer to assist in the division of a region into a predetermined number of contiguous, non-overlapping districts that completely cover the region, each district having the same population to within a predetermined tolerance, making maximum use of preexisting geopolitical boundaries. The computer programs cause the computer to automatically generate at least one super district cover comprising a set of contiguous, non-overlapping super districts that completely cover the region, each super district defined entirely by preexisting geopolitical boundaries and containing an integer multiple of the required district population to within the predetermined tolerance.

### BRIEF DESCRIPTION OF THE DRAWINGS

FIG. 1 is a county map depicting one super district cover for a North Carolina state senate election.

FIG. 2 is a county map depicting another super district cover for a North Carolina state senate election.

FIG. 3 is a county map depicting still another super district cover for a North Carolina state senate election.

FIGS. 4A-4B are flow diagrams of a method of automatically creating super district covers.

FIG. 5 is a flow diagram of a method of selecting super district covers.

FIG. 6 is a functional block diagram of a representative computing system.

### DETAILED DESCRIPTION

The method and software of the present invention are described herein with reference to the state of North Carolina, although it is applicable to any state, or indeed any region having existing geopolitical sub-divisions. Like most states, North Carolina is divided into counties. The North Carolina Senate includes 50 senators. According to the 2000 US census, the population of North Carolina was 8,049,313. Consequently, each senator represents 160,986.26 North Carolinians. For a Senate election, the state should be divided into 50 voting districts, each of which contains 160,986 residents, plus or minus 5% (a tolerance required by the North Carolina Supreme Court). According to the present invention, the task of creating 50 equal-population Senate districts is simplified—and largely insulated from tendentious political manipulation—by making maximum use of existing county borders.

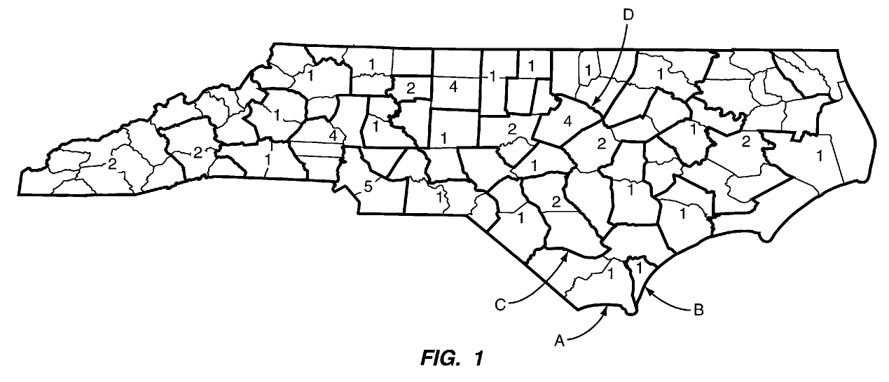

FIG. 1 depicts one super district cover for a state Senate election in the state of North Carolina. Each super district comprises one or more contiguous counties and includes an integral multiple of the required district population (e.g., 160,986), to within a predetermined tolerance (e.g., 5%). County borders are indicated in FIG. 1 by light solid lines; super districts are indicated by heavy lines. The numeral in each super district is the integral multiple of the required district population contained within the super district. For example, the super district identified in FIG. 1 as A, including Columbus, Brunswick, and Pender counties, contains the required district population between the three counties. This super district may be a Senate voting district. The super district identified in FIG. 1 as B, including only New Hanover county, also contains the required population and is a valid voting district. The super district identified in FIG. 1 as C, including Cumberland and Bladen counties, contains twice the required district population. This super district must be divided somehow to form two Senate voting districts (by the methodology of the present invention, we know that the division must be other than along the two counties' shared border). Finally, the super district identified in FIG. 1 as D, comprising only Wake county (which includes the city of Raleigh) contains four times the required district population, and must be divided into four separate Senate voting districts. Note that the sum of all super districts' population multiples equals 50, the number of Senate seats.

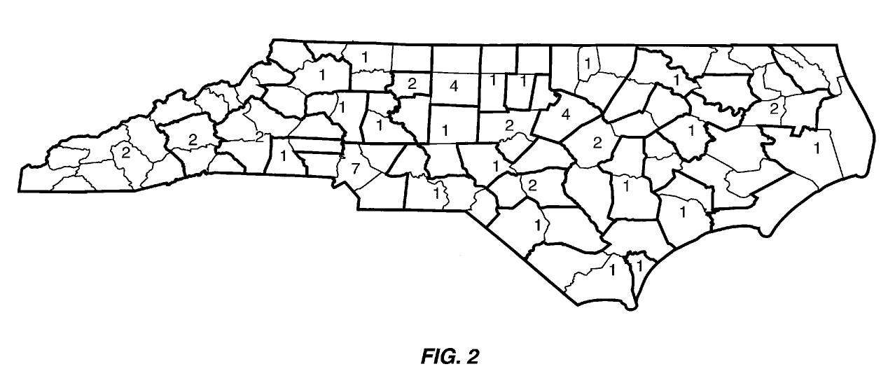

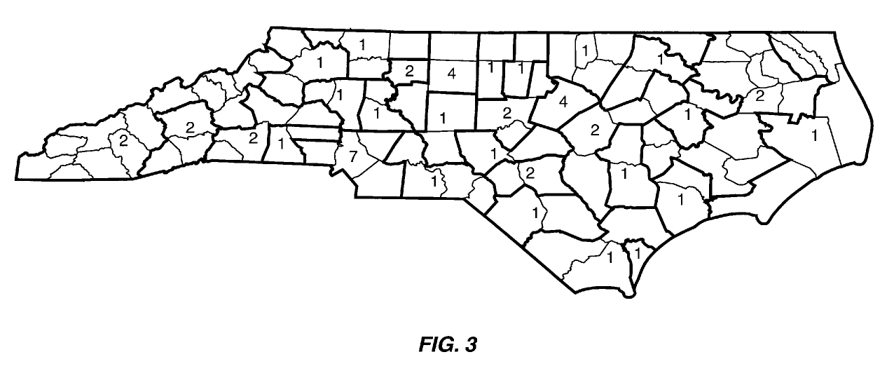

For any given state, multiple super district covers are possible. FIGS. 2 and 3 depict alternative super district covers for the state of North Carolina for a Senate election, under the same population numbers used to create the super district of FIG. 1. The super district cover provides an objective “starting point” in the redistricting process. To make maximum use of existing county boundaries, a super district cover should be selected that includes a large number of super districts containing the required district population, as opposed to a smaller number of super districts containing multiples of the required district population (which will require division not along county borders). Once a super district cover is selected, the only issue remaining for the legislature or other redistricting entity is the division of multiple-population super districts, to form multiple Senate voting districts within them.

While the present invention is described herein with reference to a North Carolina Senate election, those of skill in the art will readily recognize that it is applicable to any region that comprises preexisting geopolitical subdivisions, and is applicable to any type of election. For example, the method and software of the present invention may be used to create separate voting districts for a state's Senate and House of Representatives, to create congressional voting districts for the U.S. House of Representatives, and the like. Furthermore, the system is not limited to the use of county boundaries. For example, Virginia uses both cities and counties in its non-overlapping division of the state, while Louisiana uses parishes, and Alaska uses boroughs. Any geographical or geopolitical divisions may be used, so long as they are non-overlapping and cover the entire region. Accordingly, while the present invention is described herein with reference to aggregating counties, the invention is not so limited.

In a presently preferred embodiment, the method of creating super district covers is implemented as a software program. However, those of skill in the art will recognize that the method steps may be accomplished in other ways, such as by individual calculations and comparisons. Accordingly, the description herein of steps executed by software is illustrative and not limiting.

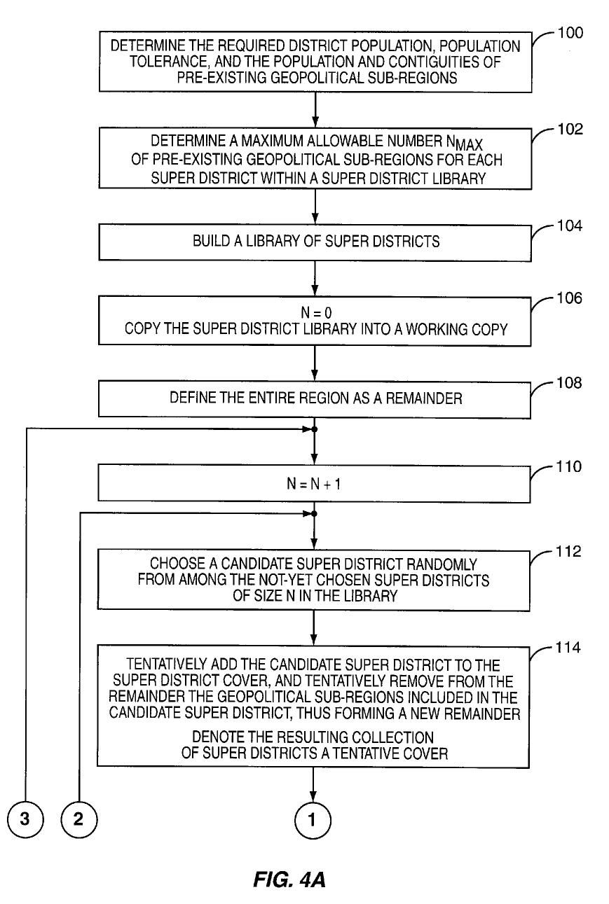

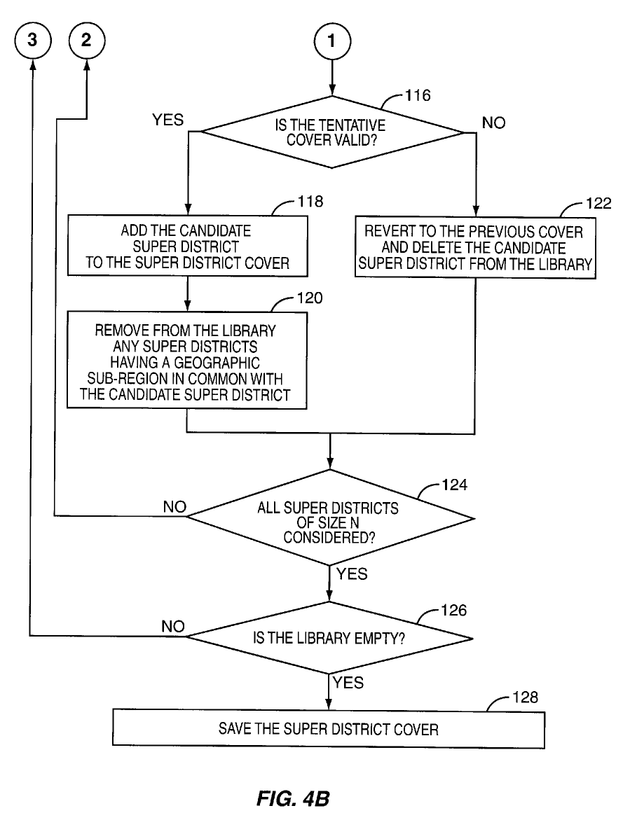

FIGS. 4A and 4B depict, in flow diagram form, a method of automatically generating at least one super district cover for a region, such as a state. The super district cover comprises a set of contiguous, non-overlapping super districts that completely cover the region, each super district defined entirely by preexisting geopolitical boundaries, such as county borders, and containing an integer multiple of the required district population to within a predetermined tolerance. Generating the super district cover assists the division of a region into a predetermined number of contiguous, non-overlapping districts that completely cover the region, each district having the same population to within a predetermined tolerance, making maximum use of preexisting geopolitical boundaries.

The process begins by determining, or acquiring, census and geopolitical information (block 100), such as a list of counties or other geographic sub-regions and their contiguities and populations. In one embodiment, this determination comprises reading one or more files containing the information; in another embodiment, it comprises accessing the information from a database; in still another embodiment it comprises accepting the information dynamically, such as by a user keying information compiled from maps and printed tables. The required district population and a district population tolerance are also determined. The required district population may be determined by dividing the population for the entire state by the number of seats to fill in a given election. The district population tolerance may be set by statute or by court or executive mandate. In one embodiment, the number of seats and the district population tolerance are read from one or more files. In another embodiment, they may be entered by a user, possibly in response to an interactive prompt or query.

The maximum allowable number “N_{MAX}” of geographic sub-regions to be aggregated into each super district in a super district library is also determined (block 102) such as by reading this limit from a file or having a user key it in. In one embodiment, N_{MAX} is six.

A library of super districts is then constructed (block 104). Each super district formed and added to the library comprises one or more contiguous geographic sub-regions, as required to contain within the super district an integer multiple of the required district population, to within the district population tolerance. An additional limitation is that no super district can be created from some but not all of the geographic sub-regions within it (i.e., no super district can itself contain a super district). Once the super district library is constructed, it may be used to construct a number of super district covers, and accordingly should be saved, as known in the art.

The remainder of FIGS. 4A and 4B describe an iterative process that is executed to create each super district cover. In general, this process comprises constructing a tentative super district cover and testing the tentative super district cover at each step to determine if it may be completed to form a valid super district cover. In particular, the super district size N (in geographic sub-regions) is initialized and a working copy of the super district library is made upon entering the iterative loop (block 106). Within the loop, the entire geographic region to be divided into voting districts is initially defined as the remainder (block 108), which is by itself a super district cover consisting of a single super district which contains all of the preexisting geographic sub-regions. The algorithm consists of breaking this remainder apart into smaller super districts by randomly chipping away super district-size areas drawn from the super district library until the library is exhausted, according greater probability of selection to the smallest super districts remaining in the library. There are various ways these probabilities of selection can be defined. In the embodiment depicted in FIGS. 4A and 4B, a method is used that gives absolute preference to the smallest super districts remaining in the library. At this point in the process, the super district size N is incremented (block 110).

At each iteration, a candidate super district is randomly selected from among the not-yet-chosen super districts of size N in the library (block 112). The selected candidate super district is then tentatively added to the super district cover under construction, and the geographic sub-regions that form the candidate super district are tentatively removed from the remainder (creating a tentative remainder) (block 114). The resulting tentative super district cover is tested to see if it is valid (block 116). The tentative super district cover is valid if its tentative remainder is a collection of one or more super districts (of any size), and if the multiples of required district populations of all the super districts in the tentative cover sum to the number of seats for an election (e.g., the size of an elected body, or the state's allocation of such seats).

If the tentative cover is valid, the candidate super district is added to the cover (block 118), and an attempt is made to break down its remainder further into smaller super districts, as long as there are any super districts remaining in the working library. Before checking to see whether there are any more super districts left in the library that can be used for this purpose, it is necessary to remove all super districts currently remaining in the library which overlap the super district most recently added to the cover under construction (block 120)—that is, any super district in the library that has a geographic sub-region in common with the candidate super district.

If the tentative super district cover is not valid (block 122), the candidate super district is removed (reverting the tentative super district cover to its previous configuration), and the candidate super district is deleted from the library because it is no longer a potential candidate super district for the particular cover under construction.

In either case—whether the candidate super district is added to the cover (block 118) or not (block 122)—the process of randomly selecting and testing a not-yet-chosen super district is attempted for yet another super district of size N (block 124). When all super districts of size N have been eliminated from the library (block 124)—either by being added to the super district cover; by being eliminated from the library because the tentative remainder, if it were added, could never become a valid super district cover; or by being eliminated from the library because it overlaps with a super district that was successfully added to the cover—N is incremented to the next larger size (N+1) (block 110), and candidate super districts of that size are randomly chosen and tested. Once the library is exhausted (block 126), the super district cover under construction is complete and is saved (block 128).

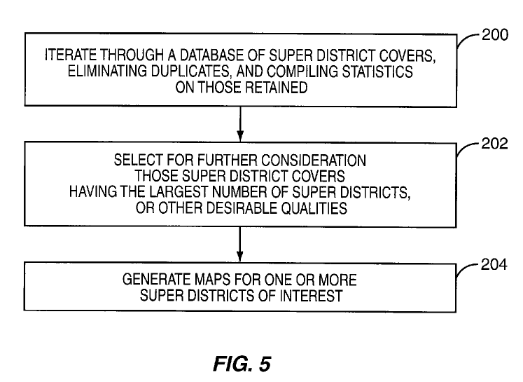

The method of FIGS. 4A and 4B may be performed repeatedly, generating several hundred or several thousand super district covers. FIG. 5 depicts a method of selecting one or more super district covers of interest from a database of super district covers. First, it is usually necessary to compare the covers to eliminate any duplicates (block 200). Statistics regarding each cover may also be compiled (block 200), including for each, the total number of super districts in the cover, the number of super districts of each size, and the size of the largest super district in the cover. Based on these statistics, the most desirable covers are identified (block 202). In one embodiment, the most desirable super district covers are those with the largest numbers of super districts and the smallest numbers of large super districts. In this way, hundreds or thousands of covers can be screened efficiently to identify those which make maximal use of existing geo-political boundaries in the formation of voting districts.

Once a small number of super district covers of particular interest has been identified, a graphic representation of the super district covers may be generated (block 204) and printed or saved. This may comprise, for example, coloring a map of the state or otherwise indicating the super district boundaries and the integral multiple of required district population contained within each super district, as in FIGS. 1-3. The maps may be rendered on a display for interactive consideration, and/or may be printed, output in the form of one or more GIF, PDF, JPG, or other image format files, or otherwise rendered in a usable form, such as tables and databases, as known in the computing arts.

The maps of super district covers may be provided to the legislature, a legislative committee, a citizen's panel, or other entity charged with creating or suggesting voting districts for the region. Using a super district cover as a starting point, the only remaining task in the redistricting process is to divide those super districts having a population greater than the required district population into the number of voting districts indicated by the population multiple. In this manner, maximum use is made of preexisting geopolitical boundaries, and the potential for gerrymandering is minimized, in redistricting a region such as a state.

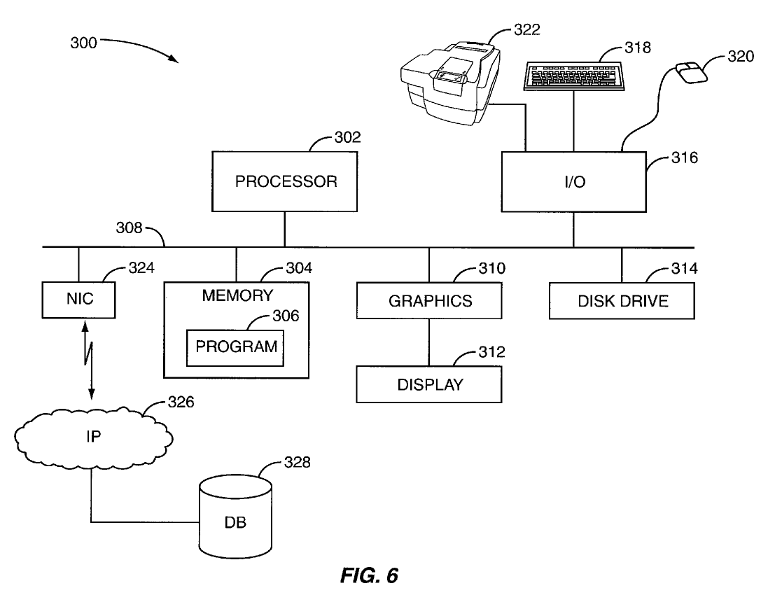

FIG. 6 depicts a functional block diagram of a representative computing system, indicated generally by the numeral 300. A processor 302, such as a microprocessor, Digital Signal Processor (DSP), state machine implemented in an FPGA or ASIC, or the like, executes instructions retrieved from memory 304. The instructions may comprise an operating system, applications software, or other programs, as known in the art. In one embodiment, a software program 306 implements a method of creating super district covers for a region, according to the present invention. The processor 302 and memory 304 may be directly coupled, or may communicate across a system bus 308, crossbar switch, or other data transfer channel, as depicted in FIG. 6.

The computer system 300 may include a graphics subsystem 310, to which a display 312 is connected, presenting text and/or graphic images to a user. The computer system 300 may additionally include one or more disk drives 314, from which the inventive software program 306 may be transferred from computer-readable media, such as a CD or magnetic disk, to the memory 304. Furthermore, the computer system 300 may include one or more Input/Output (I/O) interfaces 316, through which a user may interact with the system 300 via a keyboard 318 and pointer device 320 such as a mouse, and/or other user interface peripherals as well known in the art. The computer system 300 may direct hardcopy output, such as monochrome or colored maps depicting super district covers, to a printer 322.

In one embodiment, the computer system 300 additionally includes an interface peripheral such as a Network Interface Card (NIC) 324, which provides wired or wireless communications via an external network 326 (which may comprise an IP network such as the Internet), which in turn may connect to one or more databases 328 containing census data and/or other information related to counties or other geopolitical subdivisions of the region for which voting districts are to be created. The representative computer system 300 may execute a software program 306 creating super district covers for a region, according to the present invention.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of assisting the division of a geographic region into a predetermined number of contiguous, non-overlapping districts that completely cover the region, each district having the same population to within a predetermined tolerance, making maximum use of preexisting geopolitical boundaries, comprising automatically generating at least one super district cover comprising a set of contiguous, non-overlapping super districts that completely cover the region, each super district defined entirely by preexisting geopolitical boundaries and containing an integer multiple of the required district population to within the predetermined tolerance.

2. The method of claim 1 further comprising selecting one or more super district covers having the greatest number of super districts.

3. The method of claim 1 wherein the region is a state.

4. The method of claim 1 wherein the preexisting geopolitical boundaries comprise geographically mutually exclusive boundaries selected from the group consisting of county, borough, parish, and municipal boundaries.

5. The method of claim 1 wherein automatically generating at least one super district cover comprises:
determining the required district population;
determining the population tolerance;
determining the contiguousness of preexisting geopolitical sub-regions and the population contained within each preexisting geopolitical sub-region;
determining a maximum allowable number N_{MAX} of preexisting geopolitical sub-regions for each super district in a working library of super districts; and
automatically generating at least one super district cover based on the determined information.

6. The method of claim 5 wherein determining the required district population comprises dividing the total population of the region by a required number of districts.

7. The method of claim 6 wherein the required number of districts corresponds to a number of political offices.

8. The method of claim 5 wherein automatically generating at least one super district cover based on the determined information comprises:
building a library of super districts by combining one or more contiguous, preexisting geopolitical sub-regions to generate each super district, the super district containing an integer multiple of the required district population to within the predetermined tolerance and such that no super district can be created from some but not all of the preexisting geopolitical sub-regions; and
selecting super districts from the library to create at least one super district cover for the region.

9. The method of claim 8 wherein selecting super districts from the library to create at least one super district cover for the region comprises iteratively performing the steps of:
for each size N of preexisting geopolitical sub-regions per super district:
choosing a candidate super district randomly from among the not-yet-chosen super districts of size N;
tentatively adding the candidate super district to the super district cover;
determining whether the remaining region comprises a collection of super districts of any size;
if so, adding the candidate super district to the cover and removing from the library of not-yet-chosen super districts of size N, all super districts having a preexisting geopolitical sub-region in common with the candidate super district, and if not, excluding the candidate super district from the cover and deleting it from the library;
repeating for all super districts of size N; and
incrementing N and repeating until the library is exhausted.

10. The method of claim 9 further comprising, for each candidate super district, if the remaining region comprises a collection of super districts, determining whether the sum of the multiples of the required district population for each super district equals the predetermined number of contiguous, non-overlapping districts to be created.

11. The method of claim 9 wherein at least the step of selecting super districts from the library to create at least one super district cover for the region are performed by one or more software programs.

12. The method of claim 11 wherein the one or more software programs are further operative to perform the step of generating a map of the region for each cover, the map depicting the super district boundaries and indicating the integer multiple of the required district population contained in each super district.

13. The method of claim 12 wherein indicating the integer multiple of the required district population contained in each super district comprises printing the multiple within the super district.

14. The method of claim 12 wherein indicating the integer multiple of the required district population contained in each super district comprises outputting the map with each super district containing a different multiple depicted in a different color.

15. The method of claim 1 wherein automatically generating at least one super district cover comprises:
determining the required district population;
determining the population tolerance;
determining the contiguousness of preexisting geopolitical sub-regions and the population contained within each preexisting geopolitical sub-region; and
iteratively performing the steps of:
combining one or more contiguous, preexisting geopolitical sub-regions not in a super district, to generate a candidate super district, the candidate super district containing an integer multiple of the required district population to within the predetermined tolerance;
determining whether the remaining region can be covered by at least one set of super districts; and
if so, making the candidate super district a super district and adding the super district to the super district cover.

16. The method of claim 1, further comprising:
selecting a super district cover; and
dividing all super districts containing an integer multiple of the required district population greater than one as required to create districts containing the required district population, to within the predetermined tolerance.

17. A computer readable medium including one or more computer programs operative to cause a computer to assist in the division of a region into a predetermined number of contiguous, non-overlapping districts that completely cover the region, each district having the same population to within a predetermined tolerance, making maximum use of preexisting geopolitical boundaries, the computer programs causing the computer to automatically generate at least one super district cover comprising a set of contiguous, non-overlapping super districts that completely cover the region, each super district defined entirely by preexisting geopolitical boundaries and containing an integer multiple of the required district population to within the predetermined tolerance.

18. The computer readable medium of claim 17 wherein the computer programs further cause the computer to:
determine the required district population;
determine the population tolerance;
determine the contiguities of preexisting geopolitical sub-regions and the population contained within each preexisting geopolitical sub-region;
determine a maximum allowable number N of preexisting contiguous geopolitical sub-regions for each super district; and
automatically generate at least one super district cover based on the determined information.

19. The computer readable medium of claim 18 wherein the computer programs automatically generate at least one super district cover based on the determined information by:
building a library of super districts by combining one or more contiguous, preexisting geopolitical sub-regions to generate each super district, the super district containing an integer multiple of the required district population to within the predetermined tolerance and such that no super district can be created from some but not all of the preexisting geopolitical sub-regions; and
selecting super districts from the library to create at least one super district cover for the region.

20. The computer readable medium 19 wherein selecting super districts from the library to create at least one super district cover for the region comprises iteratively performing the steps of:
for each size N of preexisting geopolitical sub-regions per super district:
choosing a candidate super district randomly from among the not-yet-chosen super districts of size N;
tentatively adding the candidate super district to the super district cover;
determining whether the remaining region comprises a collection of super districts of any size;
if so, adding the candidate super district to the cover and removing from the not-yet-chosen super districts of size N, all super districts having a preexisting geopolitical sub-region in common with the candidate super district, and if not, excluding the candidate super district from the cover;
repeating for all super districts of size N; and
incrementing N and repeating until the library is exhausted.
